(19) United States
(12) Patent Application Publication
(10) Pub. No.: US 2024/0185033 A1
(43) Pub. Date: Jun. 6, 2024

(54) METHOD FOR TRAINING GRAPH NEURAL NETWORK, APPARATUS FOR PROCESSING PRE-TRAINED GRAPH NEURAL NETWORK, AND STORAGE MEDIUM STORING INSTRUCTIONS TO PERFORM METHOD FOR TRAINING GRAPH NEURAL NETWORK

(71) Applicant: Korea Advanced Institute of Science and Technology, Daejeon (KR)

(72) Inventors: Chanyoung PARK, Daejeon (KR); Namkyeong LEE, Daejeon (KR); Jun Seok LEE, Daejeon (KR)

(21) Appl. No.: 18/522,374

(22) Filed: Nov. 29, 2023

(30) Foreign Application Priority Data
Dec. 5, 2022 (KR) 10-2022-0168026

(51) Int. Cl. G06N 3/045

(52) U.S. Cl. CPC G06N 3/045

(57) ABSTRACT

There is provided a method of training a graph neural network. The method comprises preparing the graph neural network including a first graph neural network and a second graph neural network; generating first node embeddings representing a training graph data as vectors using the first graph neural network; generating second node embeddings representing the training graph data as the vectors using the second graph neural network; generating third node embeddings by projecting a preset predictor onto the first node embeddings; determining a loss function such that a node embedding corresponding to a query node in the training graph data among the third node embeddings and a node embedding corresponding to real positive of the query node among the second node embeddings become close to each other; and training the first graph neural network using the loss function.

### TECHNICAL FIELD

The present disclosure relates to a method and apparatus for training a graph neural network without data augmentation.

This work was partly supported by National Research Foundation of Korea (NRF) grant funded by the Korea government (MSIT; Ministry of Science and ICT) (No. 2021R1C1C1009081, Big data-based general-purpose decision support system) and Institute of Information & communications Technology Planning & Evaluation (IITP) grant funded by the Korea government(MSIT) (No.2022-0-00157, Robust, Fair, Extensible Data-Centric Continual Learning).

### BACKGROUND

A graph neural network (GNN) is a learning algorithm suitable for graph data composed of nodes and edges representing connectivity between nodes. The graph neural network is traind by accepting the graph data as an input and outputting a node representation. The graph neural network obtains embedding by repeating a process of receiving the graph data and node attribute information as inputs and aggregating information on neighboring nodes.

In order to train the graph neural network, a large amount of the graph data is required, and training is performed through data augmentation to secure a large amount of the graph data. However, unlike images, graphs have a problem of losing their inherent meanings during data augmentation.

### SUMMARY

An object of the present disclosure is to provide a method of 3D training a graph neural network without data augmentation.

The aspects of the present disclosure are not limited to the foregoing, and other aspects not mentioned herein will be clearly understood by those skilled in the art from the following description.

In accordance with an aspect of the present disclosure, there is provided a method for training a graph neural network to be performed in a graph neural network training apparatus, the method comprises: preparing the graph neural network including a first graph neural network and a second graph neural network; generating first node embeddings representing a training graph data as vectors using the first graph neural network; generating second node embeddings representing the training graph data as the vectors using the second graph neural network; generating third node embeddings by projecting a preset predictor onto the first node embeddings; determining a loss function such that a node embedding corresponding to a query node in the training graph data among the third node embeddings and a node embedding corresponding to real positive of the query node among the second node embeddings become close to each other; and training the first graph neural network using the loss function.

The determining of the loss function may include determining a predetermined first number of neighbor nodes closest to the query node using a node embedding corresponding to the query node among the first node embeddings and node embeddings corresponding to other nodes in the training graph data among the second node embeddings; determining adjacent nodes connected to the query node among the neighbor nodes as local positive; determining, as global positive, same-cluster nodes clustered into the same cluster as the query node among the neighbor nodes; and determining the real positive using the local positive and the global positive.

The real positive may be a union of the local positive and the global positive.

The loss function may be determined using cosine similarity between the node embedding corresponding to the query node in the training graph data among the third node embeddings and the node embedding corresponding to the real positive of the query node among the second node embeddings.

The method may include training the second graph neural network by accumulating parameters of the first graph neural network.

In accordance with another aspect of the present disclosure, there is provided a apparatus for training a graph neural network, the apparatus comprises: a memory configured to store the graph neural network including a first graph neural network and a second graph neural network, and one or more instructions; and a processor configured to execute the one or more instructions stored in the memory, wherein the instructions, when executed by the processor, cause the processor to: generate first node embeddings representing a training graph data as vectors using the first graph neural network, generate second node embeddings representing the training graph data as the vectors using the second graph neural network, generate third node embeddings by projecting a preset predictor onto the first node embeddings, determine a loss function such that a node embedding corresponding to a query node in the training graph data among the third node embeddings and a node embedding corresponding to real positive of the query node among the second node embeddings become close to each other, and train first graph neural network using the loss function.

In accordance with another aspect of the present disclosure, there is provided a non-transitory computer-readable recording medium storing a computer program, which comprises instructions for a processor to perform a method for training a graph neural network, the method comprise: preparing the graph neural network including a first graph neural network and a second graph neural network; generating first node embeddings representing a training graph data as vectors using the first graph neural network; generating second node embeddings representing the training graph data as the vectors using the second graph neural network; generating third node embeddings by projecting a preset predictor onto the first node embeddings; determining a loss function such that a node embedding corresponding to a query node in the training graph data among the third node embeddings and a node embedding corresponding to real positive of the query node among the second node embeddings become close to each other; and training the first graph neural network using the loss function.

In accordance with another aspect of the present disclosure, there is provided an apparatus for processing a pre-traned graph neural network, the apparatus comprises: a memory configured to store the pre-traned graph neural network including a firs t graph neural network and a second graph neural network, and one or more instructions; and a processor configured to execute the one or more instructions stored in the memory, wherein the instructions, when executed by the processor, cause the processor to: input an input graph data to the pre-traned graph neural network including the first graph neural network and the second graph neural network; and output a node representation corresponding to the input graph data using the pre-traned graph neural network including the first graph neural network and the second graph neural network, wherein the pre-traned graph neural network is traned by generating first node embeddings representing a training graph data as vectors using the first graph neural network, generating second node embeddings representing the training graph data as the vectors using the second graph neural network, generating third node embeddings by projecting a preset predictor onto the first node embeddings, determining a loss function such that a node embedding corresponding to a query node in the training graph data among the third node embeddings and a node embedding corresponding to real positive of the query node among the second node embeddings become close to each other, and training the first graph neural network using the loss function.

The pre-traned graph neural network may be traned by determining a predetermined first number of neighbor nodes closest to the query node using a node embedding corresponding to the query node among the first node embeddings and node embeddings corresponding to other nodes in the training graph data among the second node embeddings, determining adjacent nodes connected to the query node among the neighbor nodes as local positive, determining, as global positive, same-cluster nodes clustered into the same cluster as the query node among the neighbor nodes; and determining the real positive using the local positive and the global positive.

The real positive may be a union of the local positive and the global positive.

The loss function may be determined using cosine similarity between the node embedding corresponding to the query node in the training graph data among the third node embeddings and the node embedding corresponding to the real positive of the query node among the second node embeddings.

The pre-traned graph neural network may be traned bytraining the second graph neural network by accumulating parameters of the first graph neural network.

In accordance with another aspect of the present disclosure, there is provided a method for processing a pre-traned graph neural network, the method comprises: preparing the pre-traned graph neural network including a first graph neural network and a second graph neural network; inputting an input graph data to the pre-traned graph neural network including the first graph neural network and the second graph neural network; and outputting a node representation corresponding to the input graph data using the pre-traned graph neural network including the first graph neural network and the second graph neural network, wherein the pre-traned graph neural network is traned by generating first node embeddings representing a training graph data as vectors using the first graph neural network, generating second node embeddings representing the training graph data as the vectors using the second graph neural network, generating third node embeddings by projecting a preset predictor onto the first node embeddings, determining a loss function such that a node embedding corresponding to a query node in the training graph data among the third node embeddings and a node embedding corresponding to real positive of the query node among the second node embeddings become close to each other, and training the first graph neural network using the loss function.

In accordance with another aspect of the present disclosure, there is provided a non-transitory computer-readable recording medium storing a computer program, which comprises instructions for a processor to perform a method for processing a pre-traned graph neural network, the method comprise: preparing the pre-traned graph neural network including a first graph neural network and a second graph neural network; inputting an input graph data to the pre-traned graph neural network including the first graph neural network and the second graph neural network; and outputting a node representation corresponding to the input graph data using the pre-traned graph neural network including the first graph neural network and the second graph neural network, wherein the pre-traned graph neural network is traned by generating first node embeddings representing a training graph data as vectors using the first graph neural network, generating second node embeddings representing the training graph data as the vectors using the second graph neural network, generating third node embeddings by projecting a preset predictor onto the first node embeddings, determining a loss function such that a node embedding corresponding to a query node in the training graph data among the third node embeddings and a node embedding corresponding to real positive of the query node among the second node embeddings become close to each other, and training the first graph neural network using the loss function. According to an embodiment of the present disclosure, it is possible to reduce the time and economic costs required to augment data by training a graph neural network without data augmentation.

According to an embodiment of the present disclosure, it is possible to prevent the inherent meaning of a graph from being lost due to data augmentation by training a graph neural network without data augmentation to improve the accuracy of training of the graph neural network.

### BRIEF DESCRIPTION OF THE DRAWINGS

FIG. 1 is a block diagram showing a graph neural network training apparatus according to an embodiment.

FIG. 2 is a block diagram conceptually illustrating functions of a graph neural network training program according to an embodiment.

FIG. 3 is a conceptual diagram showing operations performed by the graph neural network training program to train a graph neural network according to an embodiment.

FIG. 4 shows an example in which a real positive determination unit determines real positive according to one embodiment.

FIGS. 5 and 6 are data showing the effects of training a graph neural network using the graph neural network training program according to an embodiment.

FIG. 7 is a flowchart showing a method of training a graph neural network using the graph neural network training program according to an embodiment.

FIG. 8 is a block diagram showing a graph neural network processing apparatus according to an embodiment.

### DETAILED DESCRIPTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

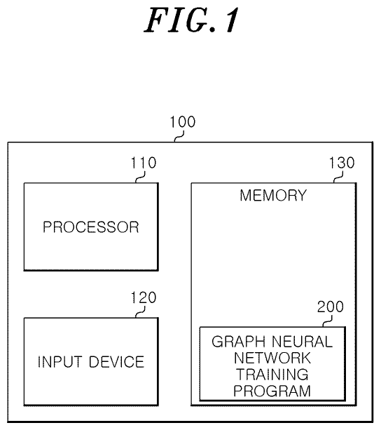

FIG. 1 is a block diagram showing a graph neural network training apparatus according to an embodiment.

Referring to FIG. 1, the graph neural network training apparatus 100 may include a processor 110, an input device 120, and a memory 130.

The processor 110 may generally control the operation of the graph neural network training apparatus 100.

The processor 110 may receive data necessary to train a graph neural network using the input device 120.

Although the graph neural network training apparatus 100 receives data necessary to train the graph neural network using the input device 120 in this specification, the present disclosure is not limited thereto. That is, according to an embodiment, the graph neural network training apparatus 100 may include a receiver (not shown) in addition to or instead of the input device 120, and the graph neural network training apparatus 100 may receive data necessary to train the graph neural network using the receiver. Accordingly, the input device 120 and/or the receiver (not shown) may be collectively referred to as an acquisition unit (not shown).

The memory 130 may store a graph neural network training program 200 and data necessary to execute the graph neural network training program 200.

The processor 110 may train a graph neural network using the graph neural network training program 200.

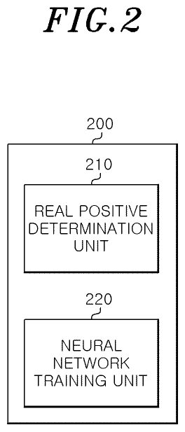

The functions and/or operations of the graph neural network training program 200 will be described in detail with reference to FIG. 2.

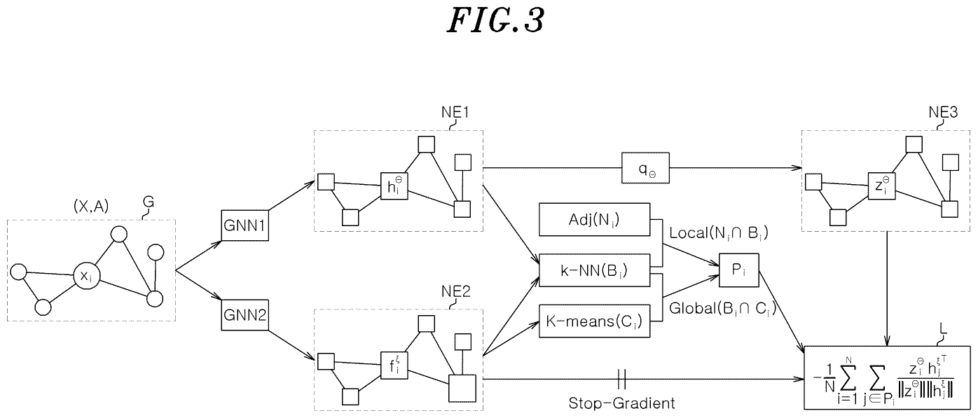

FIG. 2 is a block diagram conceptually illustrating the functions of the graph neural network training program according to an embodiment, and FIG. 3 is a conceptual diagram showing operations performed by the graph neural network training program to train a graph neural network according to an embodiment.

Referring to FIGS. 1 and 2, the graph neural network training program 200 may include a real determination unit 210 and a neural network training unit 220.

The real positive determination unit 210 and the neural network training unit 220 shown in FIG. 2 conceptually divide the functions of the graph neural network training program 200 in order to easily describe the functions of the graph neural network training program 200, and the present disclosure is not limited thereto. According to embodiments, the functions of the real positive determination unit 210 and the neural network training unit 220 may be merged/separated and implemented as a series of instructions included in one program.

The real positive determination unit 210 may determine local positive and global positive on the basis of the relationship between a query node and a neighbor node and determine real positive using the local positive and global positive.

First, the real positive determination unit 210 may determine a predetermined first number of neighbor nodes, determine local positive among the neighbor nodes on the basis of connectivity with a query node, and determine global positive among the neighbor nodes on the basis of clusters. Here, a neighbor node may mean a node having the closest distance to the query node among all nodes included in graph data.

According to the embodiment, the real positive determination unit 210 may determine neighbor nodes using a k-NN algorithm.

The real positive determination unit 210 may determine an adjacent node of the query node among the neighbor nodes as local positive. Here, the adjacent node may mean a node directly connected to the query node.

Additionally, the real positive determination unit 210 may cluster all nodes into a predetermined second number of clusters and determine a same-cluster node clustered into the same cluster as the query node among the neighbor nodes as global positive.

According to the embodiment, the real positive determination unit 210 may cluster all nodes into the second number of clusters using a k-means clustering algorithm. The real positive determination unit 210 may determine real positive Pᵢ using Equation 1 below.

Pᵢ=(Bᵢ∩Hᵢ)∪(Bᵢ∩Cᵢ) [Equation 1]

Here, Bᵢ represents a neighbor node of a query node i, Nᵢ represents an adjacent node of the query node i, and Cᵢ represents a node in the same cluster of the query node i.

That is, the real positive determination unit 210 can determine the union of the local positive and the global positive as real positive.

Referring to FIG. 3, in order to train a first graph neural network GNN1, the neural network training unit 220 may include the first graph neural network GNN1 and a second graph neural network GNN2.

The second graph neural network GNN2 is a separate neural network that is different from the first graph neural network GNN1 in at least one of the structure and parameters (weight and bias), and may be a neural network having the same purpose as the first graph neural network GNN1, that is, a neural network having the same input and output.

The first graph neural network GNN1 may receive graph data G and generate first node embeddings NE1 which represents nodes in the graph data G as vectors, and the second graph neural network GNN1 may receive the graph data G and generate second node embeddings NE2 which represents the nodes in the graph data G as vectors.

Additionally, according to the embodiment, third node embeddings NE3 may be generated by projecting a preset predictor q_{θ} onto the first node embeddings NE1.

The real positive determination unit 210 may determine neighbor nodes Bᵢ of a query node xᵢ using a node embedding hᵢ^{θ}, that represents the query node xᵢ as a vector from among the first node embeddings EN1 and node embeddings that represent other nodes as vectors from among the second node embeddings NE2.

Further, the real positive determination unit 210 may determine a same cluster node Cᵢ of the query node xᵢ using the second node embeddings NE2.

The real positive determination unit 210 may determine the adjacent node Nᵢ of the query node xᵢ among the neighbor nodes Bᵢ as local positive, determine the same cluster node Cᵢ among the neighbor nodes Bᵢ as global positive, and determine the union of local positive and global positive as real positive.

The neural network training unit 220 may determine a loss function used to train the first graph neural network GNN1 using the second node embeddings NE2 and the third node embeddings NE3.

More specifically, the neural network training unit 220 can determine the loss function L used to train the first graph neural network GNN1 using Equation 2 below.

$$ℒ = - \frac{1}{N} {\sum }_{i = 1}^{N} {\sum }_{j ∈ {P}_{i}} \frac{{z}_{i}^{θ} {h}_{j}^{{ξ}^{T}}}{‖ {z}_{i}^{θ} ‖ ‖ {h}_{j}^{ξ} ‖} \qquad [ Equation 2 ]$$

Here, L represents the loss function, N represents the number of nodes included in the graph data G, Pᵢ represents the real positive of the query node i, zᵢ^{θ} represents a node embedding corresponding to the query node i in the third node embeddings NE3, and hⱼ^{ξ} represents a node embedding corresponding to the real positive in the second node embeddings NE2.

That is, the neural network training unit 220 can determine the loss function L such that the query node represented by the third node embeddings and the real positive represented by the second node embeddings are similar (close).

As can be ascertained from Equation 2, the loss function L can be obtained by converting cosine similarity into a negative number according to the embodiment. That is, similarity between two vectors increases as the cosine similarity value increases. Since the first graph neural network GNN1 will be trained (updated) such that the loss function L becomes smaller, the loss function can be obtained by converting the cosine similarity into a negative number such that the loss function L becomes smaller as the similarity increases.

The neural network training unit 220 may train the first graph neural network GNN1 by inputting the loss function L into the first graph neural network GNN1.

In addition, the neural network training unit 220 may train the second graph neural network GNN2 while accumulating parameters (e.g., weights) of the first graph neural network GNN1 (e.g., applying an exponentially weighted averages (EMA) method to the first graph neural network GNN1.

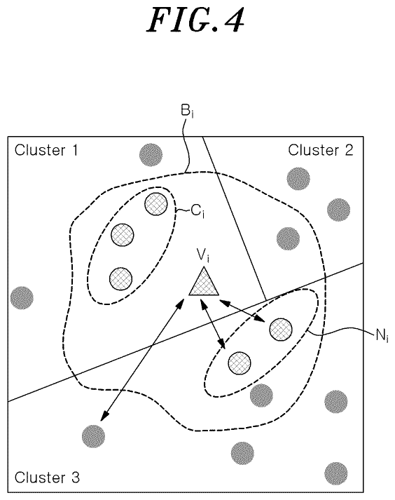

FIG. 4 shows an example in which the real positive determination unit determines real positive according to an embodiment.

Referring to FIGS. 2 and 4, when the first number is 7, the real positive determination unit 210 may determine 7 neighbor nodes Bᵢ close to a query node vᵢ.

The real positive determination unit 210 may determine adjacent nodes Nᵢ of the query node vᵢ among the neighboring nodes Bᵢ as local positive.

When the second number is 3, the real positive determination unit 210 may cluster all nodes included in graph data into 3 clusters, and determine same-cluster nodes Cᵢ clustered into the same cluster as the query node vᵢ among the neighbor nodes Bᵢ as global positive.

The real positive determination unit 210 may determine the union of the local positive and the global positive as real positive.

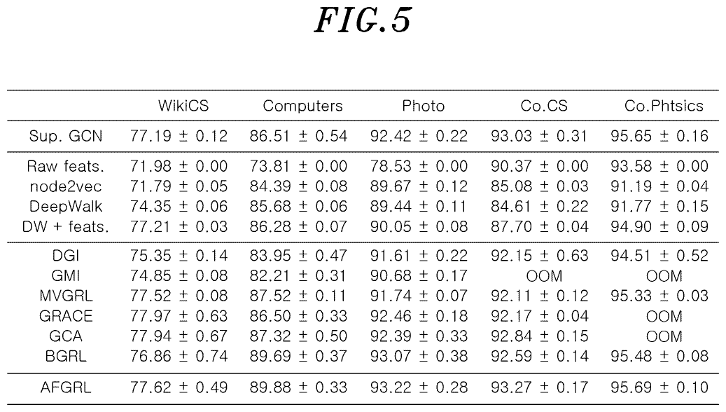

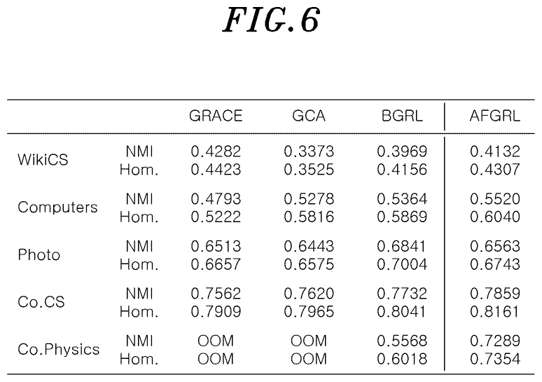

FIGS. 5 and 6 are data showing the effects of training a graph neural network using the graph neural network training program according to an embodiment.

Referring to FIGS. 1, 2, 5, and 6, AFGRL represents a graph neural network trained using the graph neural network training program 200, and Sup. GCN, Raw feats, node2vec, DeepWalk, DW+feats., DGI, GMI, MVGRL, GRACE, GCA, and BGRL represent graph neural networks trained by different conventional methods.

FIG. 5 shows the performance when node classification is performed using each graph neural network, and FIG. 6 shows the performance when node clustering is performed using each graph neural network.

It can be ascertained from FIGS. 5 and 6 that the graph neural network trained using the graph neural network training program 200 shows similar or better performance as compared to the graph neural networks trained using other conventional methods.

Although performance differences between the graph neural network trained using the graph neural network training program 200 and the graph neural networks trained using other conventional methods may be considered insignificant, the learning method using the graph neural network training program 200 can train a graph neural network without data augmentation and thus shows similar or better performance than the graph neural networks trained using other methods while considerably reducing the time and economic costs required for learning. Accordingly, the learning method using the graph neural network training program 200 can be regarded as a considerably excellent learning method.

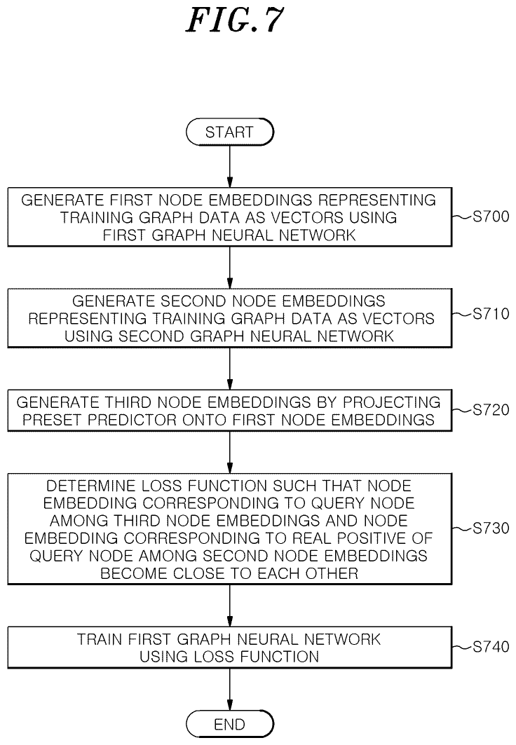

FIG. 7 is a flowchart showing a method of training a graph neural network using the graph neural network training program according to an embodiment.

Referring to FIGS. 1, 2, 3, and 7, the real positive determination unit 210 may generate first node embeddings NE1 representing graph data G as vectors using a first graph neural network GNN1 (S700), generate second node embeddings NE2 representing the graph data G as vectors using a second graph neural network GNN2 (S710), and generate third node embeddings NE3 by projecting a preset predictor q_{θ} onto the first node embeddings NE1 (S720).

The neural network training unit 220 may determine a loss function L such that a node embedding zᵢ^{θ} corresponding to a query node xᵢ among the third node embeddings NE3 and a node embedding hⱼ^{ξ} corresponding to real positive of the query node xᵢ among the second node embeddings NE2 becomes close to each other (S730).

The neural network training unit 220 may train the first graph neural network GNN1 using the loss function L (S740).

Meanwhile, although steps S700, S710, and S720 are sequentially performed in FIG. 7 for convenience of explanation, the present disclosure is not limited thereto. That is, one or more of steps S700, S710, and S720 may be performed sequentially or in parallel.

According to an embodiment of the present disclosure, it is possible to reduce time and economic costs required to augment data by training a graph neural network without data augmentation.

According to an embodiment of the present disclosure, it is possible to prevent the inherent meaning of graph from being lost due to data augmentation by training a graph neural network without data augmentation, thereby improving the accuracy of training of the graph neural network.

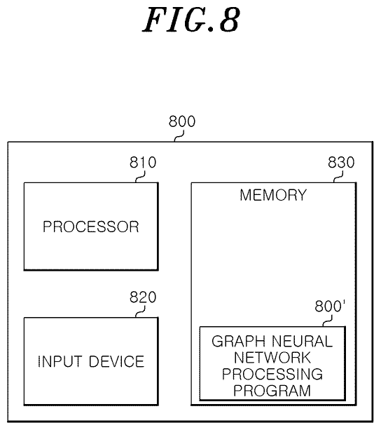

FIG. 8 is a block diagram showing a graph neural network processing apparatus according to an embodiment.

Referring to FIG. 8, the graph neural network processing apparatus 800 may include a processor 810, an input device 820, and a memory 830.

The processor 810 may generally control the operation of the graph neural network processing apparatus 800.

The processor 810 may receive data necessary to process a graph neural network using the input device 820.

Although the graph neural network processing apparatus 800 receives data necessary to process the graph neural network using the input device 120 in this specification, the present disclosure is not limited thereto. That is, according to an embodiment, the graph neural network processing apparatus 800 may include a receiver (not shown) in addition to or instead of the input device 820, and the graph neural network processing apparatus 800 may receive data necessary to process the graph neural network using the receiver. Accordingly, the input device 820 and/or the receiver (not shown) may be collectively referred to as an acquisition unit (not shown).

The memory 830 may store a graph neural network processing program 800′ and data necessary to execute the graph neural network processing program 800′.

The processor 810 may process a graph neural network using the graph neural network processing program 800′. Herein the graph neural network may include a neural network trained by the graph neural network training apparatus 100 discribed in the FIG. 1.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A method for training a graph neural network to be performed in a graph neural network training apparatus, the method comprising:
preparing the graph neural network including a first graph neural network and a second graph neural network;
generating first node embeddings representing a training graph data as vectors using the first graph neural network;
generating second node embeddings representing the training graph data as the vectors using the second graph neural network;
generating third node embeddings by projecting a preset predictor onto the first node embeddings;
determining a loss function such that a node embedding corresponding to a query node in the training graph data among the third node embeddings and a node embedding corresponding to real positive of the query node among the second node embeddings become close to each other; and
training the first graph neural network using the loss function.

2. The method of claim 1, wherein the determining of the loss function includes:
determining a predetermined first number of neighbor nodes closest to the query node using a node embedding corresponding to the query node among the first node embeddings and node embeddings corresponding to other nodes in the training graph data among the second node embeddings;
determining adjacent nodes connected to the query node among the neighbor nodes as local positive;
determining, as global positive, same-cluster nodes clustered into the same cluster as the query node among the neighbor nodes; and
determining the real positive using the local positive and the global positive.

3. The method of claim 2, wherein the real positive is a union of the local positive and the global positive.

4. The method of claim 1, wherein the loss function is determined using cosine similarity between the node embedding corresponding to the query node in the training graph data among the third node embeddings and the node embedding corresponding to the real positive of the query node among the second node embeddings.

5. The method of claim 1, further comprising training the second graph neural network by accumulating parameters of the first graph neural network.

6. An apparatus for processing a pre-traned graph neural network, comprising:
a memory configured to store the pre-traned graph neural network including a first graph neural network and a second graph neural network, and one or more instructions; and
a processor configured to execute the one or more instructions stored in the memory, wherein the instructions, when executed by the processor, cause the processor to:
input an input graph data to the pre-traned graph neural network including the first graph neural network and the second graph neural network; and
output a node representation corresponding to the input graph data using the pre-traned graph neural network including the first graph neural network and the second graph neural network,
wherein the pre-traned graph neural network is traned by generating first node embeddings representing a training graph data as vectors using the first graph neural network, generating second node embeddings representing the training graph data as the vectors using the second graph neural network, generating third node embeddings by projecting a preset predictor onto the first node embeddings, determining a loss function such that a node embedding corresponding to a query node in the training graph data among the third node embeddings and a node embedding corresponding to real positive of the query node among the second node embeddings become close to each other, and training the first graph neural network using the loss function.

7. The apparatus of claim 6, wherein the pre-traned graph neural network is traned by determining a predetermined first number of neighbor nodes closest to the query node using a node embedding corresponding to the query node among the first node embeddings and node embeddings corresponding to other nodes in the training graph data among the second node embeddings, determining adjacent nodes connected to the query node among the neighbor nodes as local positive, determining, as global positive, same-cluster nodes clustered into the same cluster as the query node among the neighbor nodes; and determining the real positive using the local positive and the global positive.

8. The apparatus of claim 7, wherein the real positive is a union of the local positive and the global positive.

9. The apparatus of claim 6, wherein the loss function is determined using cosine similarity between the node embedding corresponding to the query node in the training graph data among the third node embeddings and the node embedding corresponding to the real positive of the query node among the second node embeddings.

10. The apparatus of claim 6, wherein the pre-traned graph neural network is traned bytraining the second graph neural network by accumulating parameters of the first graph neural network.

11. A non-transitory computer readable storage medium storing computer executable instructions, wherein the instructions, when executed by a processor, cause the processor to perform a method of training a graph neural network, the method comprising:
preparing the graph neural network including a first graph neural network and a second graph neural network;
generating first node embeddings representing a training graph data as vectors using the first graph neural network;
generating second node embeddings representing the training graph data as the vectors using the second graph neural network;
generating third node embeddings by projecting a preset predictor onto the first node embeddings;
determining a loss function such that a node embedding corresponding to a query node in the training graph data among the third node embeddings and a node embedding corresponding to real positive of the query node among the second node embeddings become close to each other; and
training the first graph neural network using the loss function.

12. The non-transitory computer readable storage medium of claim 11, wherein the determining of the loss function includes:
determining a predetermined first number of neighbor nodes closest to the query node using a node embedding corresponding to the query node among the first node embeddings and node embeddings corresponding to other nodes in the training graph data among the second node embeddings;
determining adjacent nodes connected to the query node among the neighbor nodes as local positive;
determining, as global positive, same-cluster nodes clustered into the same cluster as the query node among the neighbor nodes; and
determining the real positive using the local positive and the global positive.

13. The non-transitory computer readable storage medium of claim 12, wherein the real positive is a union of the local positive and the global positive.

14. The non-transitory computer readable storage medium of claim 11, wherein the loss function is determined using cosine similarity between the node embedding corresponding to the query node in the training graph data among the third node embeddings and the node embedding corresponding to the real positive of the query node among the second node embeddings.

15. The non-transitory computer readable storage medium of claim 11, further comprising training the second graph neural network by accumulating parameters of the first graph neural network.
